(19) United States
(12) Patent Application Publication
(10) Pub. No.: US 2015/0239679 A1
(43) Pub. Date: Aug. 27, 2015

(54) SINGULATOR FOR ROUNDED ITEMS

(71) Applicant: NEWTEC A/S, Odense M (DK)

(72) Inventors: Ivar MAGNUSSON, Odense (DK); Ulrik THRANE, Harndrup (DK)

(21) Appl. No.: 14/629,240

(22) Filed: Feb. 23, 2015

(30) Foreign Application Priority Data
Feb. 21, 2014 (DK) PA 2014 00096

(51) Int. Cl. B65G 47/68

(52) U.S. Cl. CPC B65G 47/682

(57) ABSTRACT

Packing large rounded articles in smallish bags requires singulation. According to the invention, a full portion is released at the upstream end of a V-shaped structure created by conveyor belts. The V-shaped structure carries the rounded articles to the packing station. At the beginning of the operation, a section of one side of the V-shaped structure is prevented from contributing to the forward transport of the articles, and they are rotated by the other side of the V-shaped structure. As the operation proceeds while the portion is broken up, the inactive section of the conveyor belt is made active, and the articles are now carried singly at full speed to the packing station.

### CROSS-REFERENCE TO RELATED APPLICATIONS

This application claims priority to Danish (DK) Application Number PA 2014 00096, entitled “A Singulator for Rounded Items,” filed Feb. 21, 2014, which is incorporated herein by reference in its entirety.

### BACKGROUND OF THE INVENTION

1. The Field of the Invention

The present invention relates to a singulator for rounded items. More specifically, the present invention relates to one or more conveyor belts which is capable of moving the rounded items individually forward for transport or further processing.

2. The Relevant Technology

Singulators are used when a clump or group of items have been collected, and it is desired to transport them singly for further processing. A particular problem is met when it is desired to pack items into bags, for instance fruits that are portioned by counting or weighing. If the dimension of the fruit is so large that two pieces of fruit cannot pass the opening of the bag simultaneously, there is a considerable risk of jamming, which causes delays. Jams may be sorted out, but it takes time, has to occur against the friction of the conveyor belt that carries the fruit, and against the time pressure of more fruit arriving. For this reason it is considered preferable to have the fruit arrive one at a time, but in quick succession. A well-known way of transporting fruit is by means of conveyor belts (endless conveyors) forming a V-shaped channel or trough. This eliminates the need for railings or guide rails and centers the fruit.

There is a difference between loosening-up a large quantity of items, conveying them individually forward, and then conveying of a particular batch of items (batched by weight or number) to a packing station. The difference lies in the way that capacity may be increased. In the loosening-up situation the conveyor may simply run faster, but in the batch situation there is risk of jams that take longer to resolve, unless the conveyor is made considerably longer than a row of items.

In order to solve these problems, many types of singulators are known in the art. U.S. Pat. No. 7,278,530 describes a singulator, in which a V-formed channel is made from conveyor belts in planes perpendicular to each other, in which one plane has a number of parallel conveyor belts moving at speeds that decrease the further they are from the bottom of the V. However, this singulator has its main advantage when dissolving a collection of items having arrived in bulk. It is also complex in its operation.

U.S. Pat. No. 5,647,473 also handles items arriving in bulk, but the singulation occurs by stretches of conveyor belt that have increasing speeds, while items that are too close together on the highest-speed conveyor are blown off by an air cannon.

A different approach is taken in U.S. Pat. No. 6,170,637 in which round fruit is transported by means of a series of closely-spaced rollers. This is a mechanically a very complex machine that requires fine adjustment.

Each of these solutions, however, has significant drawbacks and there is still need in the art for a more efficient singulator than those currently known in the art.

The subject matter claimed herein is not limited to embodiments that solve any disadvantages or that operate only in environments such as those described above. Rather, this background is only provided to illustrate one exemplary technology area where some embodiments described herein may be practiced

### BRIEF SUMMARY OF THE INVENTION

These and other limitations are overcome by embodiments of the invention which relate to a singulator for rounded items. The singulator comprises one or more conveyor belts which move the rounded items forward while defining a V-shaped channel having two inwards-facing surfaces, in which one surface has defined a downstream section and an upstream section. Singulators are typically used for sorting or conveying a variety of rounded items including fruits or other vegetable produce, such as celeriacs or baking potatoes or even bell peppers.

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

It has been determined that a novel and efficient solution to the problem of singulating a batch composed of a predefined number or weight of items may be found in a singulator according to the invention, which is particular in that the upstream section or part of one of the conveyor belts in the V-configuration comprises means for holding its surface stationary in a first phase of a singulation operation, said upstream section further comprising means for its forward movement in a second phase of the singulation operation.

Herein, the terms ‘upstream’ and ‘downstream’ are to be taken in their ordinary technical meaning, meaning that an ‘upstream’ item is placed closest to the beginning of a stretch of conveyor belt and a ‘downstream’ item is placed closest to the end of a stretch of conveyor belt, it being understood that the conveying in a forward movement occurs from a position ‘upstream’ to a position ‘downstream,’ where it is subsequently transported away. The expressions ‘conveyor belts in V-configuration’, ‘V-shaped structure’, and ‘V-shaped channel’ are interchangeable.

An advantageous embodiment of the invention is particular in that the means for holding the surface of the upstream section stationary comprises a plate covering the upstream section such that the rounded items are not in contact therewith, and that the means for the forward movement of the upstream section also comprises a means for displacing said plate in its plane to permit contact between the rounded items and the upstream section. A shielding plate held at a small distance from part of a conveyor belt effectively prevents the conveyor belt from transmitting motion to an object that currently rests against the plate, rather than against the moving conveyor belt surface. If this plate is moved in its own plane to make the moving conveyor belt surface appear, the formerly shielded part of the conveyor belt will contribute transportation of the items.

A further advantageous embodiment of the invention is particular in that said plate is hinged at one point and is capable of being swung upwards out of the way of the upstream surface it covers. Hinging the plate at one end will permit an angular motion of the plate in its own plane, and hence provide access to the moving conveyor belt below.

A further advantageous embodiment of the invention is particular in that said plate is capable of being displaced laterally upwards out of the way of the upstream surface it covers. Rather than hinging the plate the present embodiment provides parallel motion in the plane of the plate, thereby providing access to the moving conveyor belt below. It will be understood that in case the plane plate is replaced by a part of a cylindrical shell with an axis parallel to the V-shaped structure, then swinging the part cylindrical shell around said axis out of the way of the upstream surface it covers, is fully equivalent to shifting a plate in a parallel movement.

A further advantageous embodiment of the invention is particular in that the displaceable plate has means for the adjustment of the length along the conveyor of the lower edge of said plate. The length of the plate determines the number of items that are either prevented from being acted on by the moving conveyor belt or when the plate is displaced according to the invention being conveyed by this side of the V-shaped conveyor belt structure as well.

A further advantageous embodiment of the invention is particular in that the downstream section and the upstream section are separate conveyor belts on the same side of the V-shaped channel, and in that said means for holding the surface of the upstream section stationary consists in maintaining the upstream conveyor belt immobile, and that the means for the forward movement of the surface are means for moving said upstream conveyor belt forward. By having one side of the V-shaped conveyor belt structure made as two subsequent conveyor belts, it is possible to control their speeds individually, and by completely stopping the upstream part, the items are rotated by the other belt in the V-shaped conveyor belt structure, until this upstream part is given speed, in which case the items will be conveyed with no appreciable rotation by the V-shaped conveyor belt structure.

A further advantageous embodiment of the invention is particular in that the downstream section moves at a speed that is equal to or greater than the speed of the other conveyor belt, and that the upstream section does not move during the first phase of the singulation operation and is put in motion at the same speed as the downstream section during the second phase of the singulation operation. This embodiment permits the fine-tuning of the singulation capacity because it involves the speeds of three conveyor belt sections, including the upstream conveyor belt that may be stopped, and the downstream conveyor belt on the same side that may have a speed that is greater than the conveyor belt forming the other side of the V-shaped conveyor belt structure.

An advantageous use of the singulation apparatus according to the invention is particular in that it comprises the following steps: emptying a portion consisting of a pre-determined number or weight of fruit into the upstream section of the V-shaped channel while the upstream section of one surface is stationary, permitting the downstream section and the other conveyor belt to arranging the fruit into a row, making the upstream section move with a speed corresponding to the speed of the other conveyor, thereby transporting the last fruit of the portion, and transporting the singulated fruit for further processing. The precise timing of the change between a stationary surface and a moving surface is easily determined by the skilled person in order to obtain a throughput that is commensurable with the subsequent processing, such as bagging.

A further advantageous use of a singulation apparatus according to a specific embodiment of the invention is particular in that it comprises the following steps: emptying a portion consisting of a pre-determined number or weight of fruit into the upstream section of the V-shaped channel while a plate covers the upstream section of one surface, permitting the downstream section and the other conveyor belt to pull fruit into a row, shifting the plate covering the upstream section of the surface in its plane to give access for the fruit to the moving surface, thereby transporting the last fruits of the portion, and transporting the singulated fruit for further processing. The precise timing of the change between presenting a plane surface and moving the surface to expose the underlying moving surface is easily determined by the skilled person in order to obtain a throughput that is commensurable with the subsequent processing, such as bagging.

A further advantageous use of a singulation apparatus according to a different specific embodiment of the invention is particular in that it comprises the following steps: emptying a portion consisting of a pre-determined number or weight of fruit into the upstream section of the V-shaped channel while the upstream conveyor belt on one side of the V-shaped channel is stationary, permitting the downstream conveyor belt on said side and the other conveyor belt to arrange the fruit into a row, making the upstream conveyor belt move with a speed corresponding to the speed of the other conveyor belt, thereby transporting the last fruits of the portion, and transporting the singulated fruit for further processing. The precise timing of the change between a stationary upstream conveyor belt and a moving upstream conveyor belt is easily determined by the skilled person in order to obtain a throughput that is commensurable with the subsequent processing, such as bagging.

It will be understood that the plane plate shifted in its plane may be replaced by a part of a cylindrical shell with an axis parallel to the V-shaped structure. When fitted with brackets such a shell may be swung about the axis, from a position where it covers the upstream surface to where it gives access to the underlying conveyor belt.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a perspective view of a portion of round fruit having just been released into the V-shaped space between two conveyors,

FIG. 2 shows the same perspective as FIG. 1, but slightly later but still in the first phase of the singulation operation,

FIG. 3 shows the second phase of the singulation operation,

FIG. 4 shows a plate partially shielding the conveyor belt from the fruit in the first phase of the singulation operation,

FIG. 5 shows the plate in the position it takes in the second phase of the singulation operation,

FIG. 6 shows the splitting of one belt conveyor into two, and

FIG. 7 shows elements that prevent access to the movement of the conveyor belt surface during part of the singulating operation.

### DETAILED DESCRIPTION OF THE PREFERRED EMBODIMENTS

Embodiments of the invention relate to a singulator for large rounded articles. The general principle of the invention as a solution to the problem of packing large rounded articles in bags, where the opening of the bags varies from a size which is not much larger than the average diameter of the rounded articles to about twice the diameter of the rounded articles. The packing process is based upon the sorting or singulation of a full portion or large group of the rounded articles at the head or upstream section of a V-shaped structure created by conveyor belts. The V-shaped structure carries the rounded articles, typically fruit, to the packing station. One characteristic feature of the invention is that at the beginning of the release-transport operation, a section of one side of the V-shaped structure does not contribute to the forward transport of the fruit, either because an intervening plate prevents the fruit from touching the moving surface, or because the moving surface has been forced to be immobile at the beginning of the release-transport operation. As the transport operation proceeds while the portion is broken up, the inactive section of the conveyor belt is made active, either by lifting the intervening plate or by setting that section of the conveyor belt in motion.

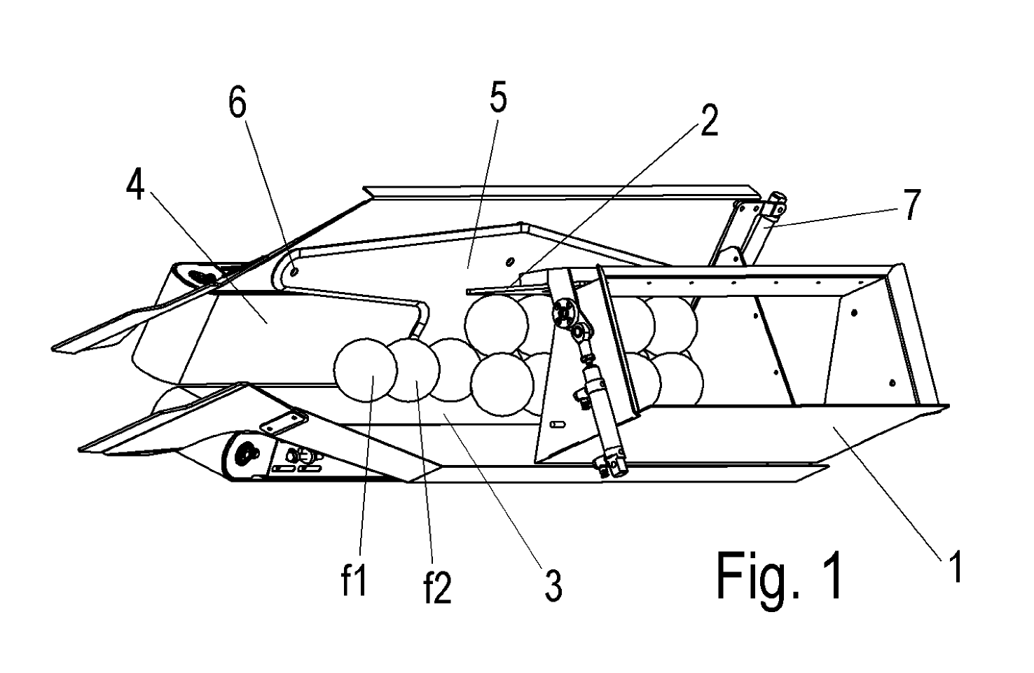

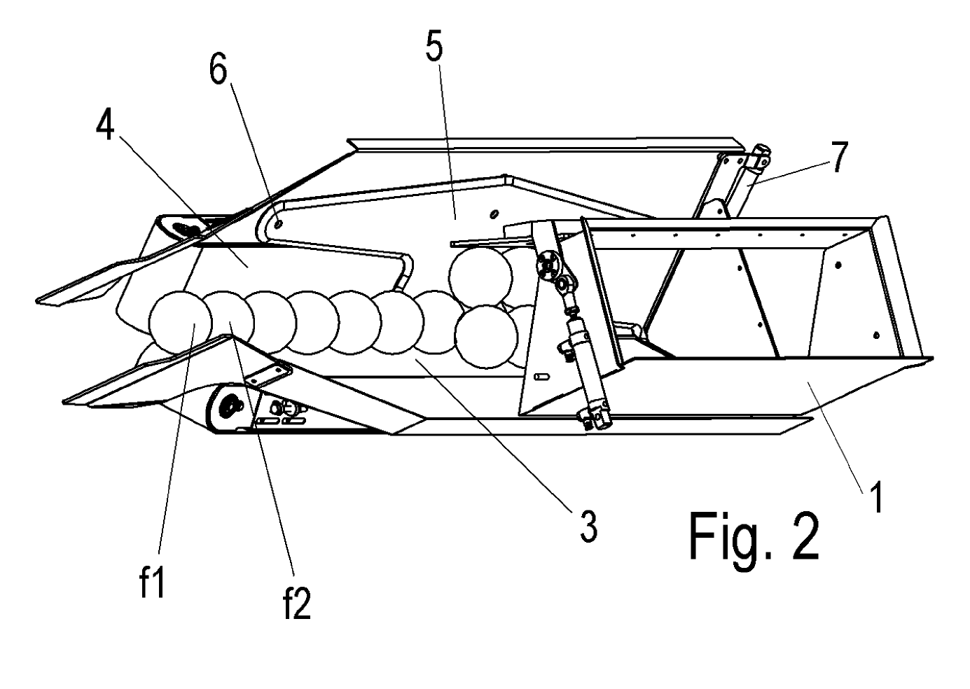

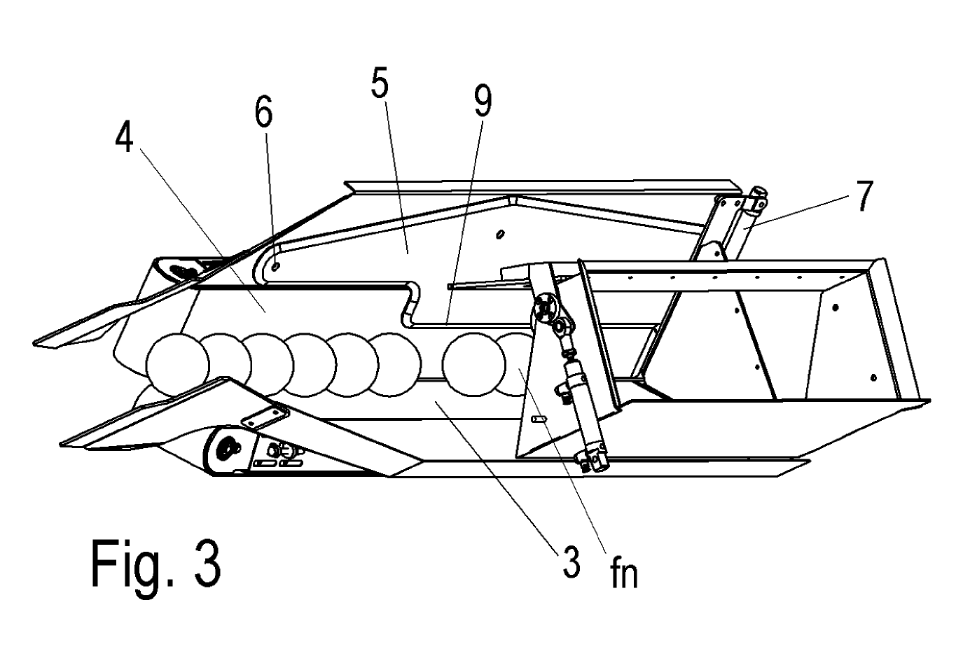

FIG. 1 illustrates a box or hopper 1 with an opened bottom 2. The box 1 previously held a group of the round fruit f1, f2, f3, . . . fn that has now been discharged. This portion is to be bagged at the other end of the conveying system from discharge to packing machine. The bottom 2 plays no further role in the operation. The fruits are in this case large, round fruits, such as grapefruits or large oranges. The discharge occurred into the upstream section of the V-shaped moving channel consisting of the belt conveyors 3 and 4 moving from right to left in the figure. The conveyor belts may have supporting or backing plates on the side facing away from the fruit. The foremost fruits f1 and f2 are transported away through the action of the conveyor belts 3 and 4, and as the remaining fruits are pushed by the nearest conveyor belt 3, and while resting against the plate 5. The plate 5 is an example of a holder as is recited in the claims below. The fruits f1 and f2 are rotated at approximately half-speed and moved to the left in the figure, where they are caught between the two conveyor belts 3 and 4 and transported away as well, this time at full conveyor speed. This process is shown in FIG. 2. This first phase of the singulation operation occurs until all of the fruit has reached the low level in the opening of the V, whereupon the second phase of the singulation operation takes place by raising the plate 5 as shown in FIG. 3. Now all the fruit is in contact with both the moving conveyor belts 4 and 5, and the last fruit fn is carried along.

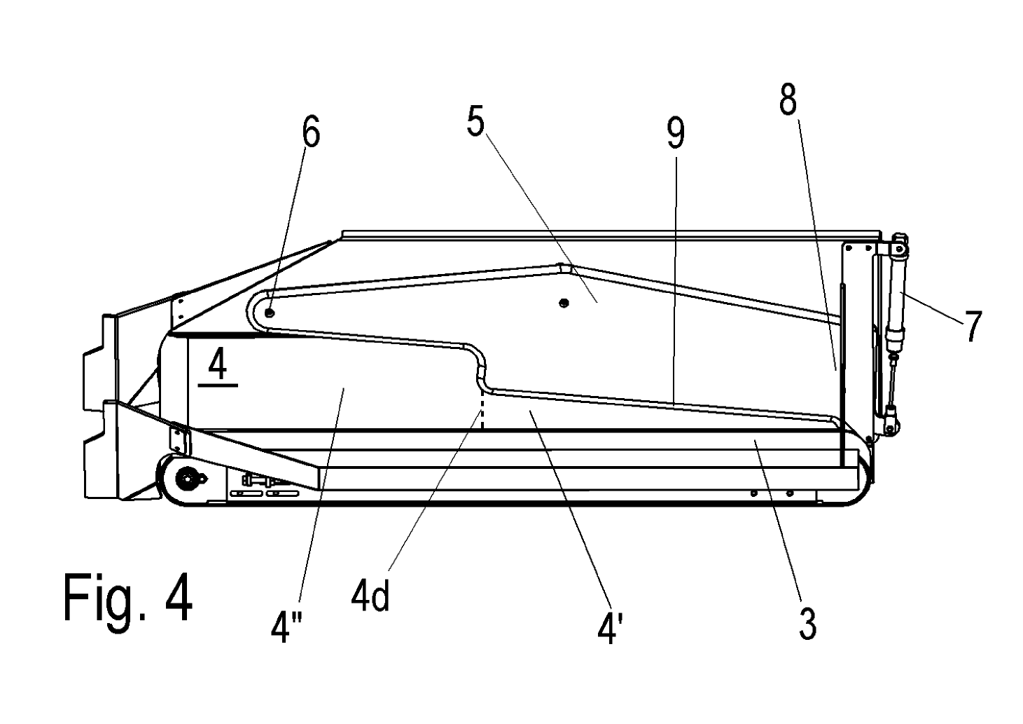

FIG. 4 illustrates how the plate 5 is disposed with respect to the conveyor belt 4. It is hinged or pivoted at the point 6, and it is actuated by means of a pneumatic cylinder 7 or an equivalent device at the other end 8. The pneumatic cylinder 7 is an example of the movement mechanism recited in the claims below. An imaginary dividing line 4d has been shown between the upstream section 4′ of the conveyor belt 4 and the downstream section 4″. In the first part of the singulating operation the plate 5 covers the upstream section 4′ in such a way that round fruit cannot obtain contact with the moving conveyor belt, i.e. the plate 5 extends at least as far down that its lower edge 9 is less than a half-diameter of the fruit above the other support plane, which is conveyor belt 3. The fruit is rotated by the conveyor belt 3, essentially moving forward at half-speed when compared to the speed of conveyor belt 3 and breaking up the portion that was discharged by the hopper as described with respect to FIG. 1.

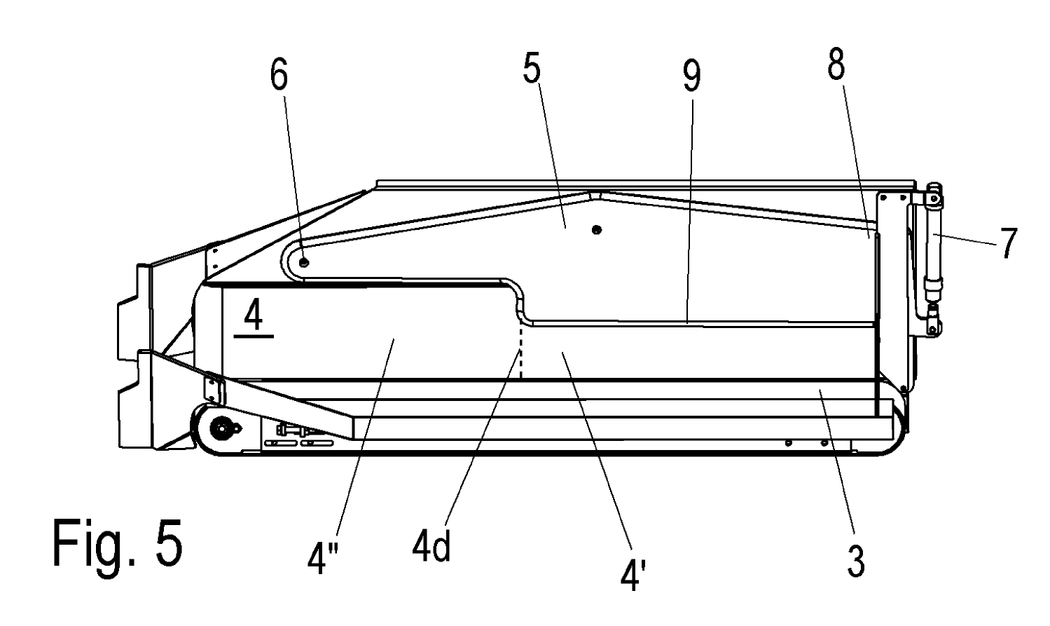

In the second phase of the singulating operation shown in FIG. 5 the plate 5 has been lifted by means of the cylinder 7 so that its lower edge 9 is now above the line where an average fruit touches the conveyor section 4′. This means that the remaining fruit placed in this area is now in contact with both forward moving conveyor belts 3 and 4, and hence) moves forward at full speed without rotating.

The position of the dividing line between the sections of belt conveyor 4 (imaginary line 4d) that carry out different functions may be optimized according to the requirements of the equipment, such as friction, size of the items to be singulated, and the speed of the conveyor belts 3 and 4. This determination falls within the abilities of a skilled person in the art. In the present embodiment, this may be obtained by making the edge 9 longer or shorter as required, and it is typically performed by adjusting a sliding part of the plate 5 before beginning singulation of new batches of rounded articles. Another, simple, solution is to exchange plate 5 for a plate having the dimensions particularly appropriate for a specific type of singulation operation.

Concerning the present embodiment, the following observations have been made: when the V-shaped channel formed of the conveyors 3 and 4 is moving forward at a surface velocity of 0.6 ms and the plate 5 is lifted, the time required to singulate a batch of 12 round fruit (large oranges) released by the chute is approximately 3 seconds. This corresponds to singulating by means of an ordinary V-shaped transport channel. When the apparatus is working according to the present invention, the same time is reduced to approximately 2.5 seconds. This is an appreciable increase of capacity. It is obvious to the skilled person that variations in the dimension and friction of the fruit will materially influence the absolute values, but the decrease in required time is consistent.

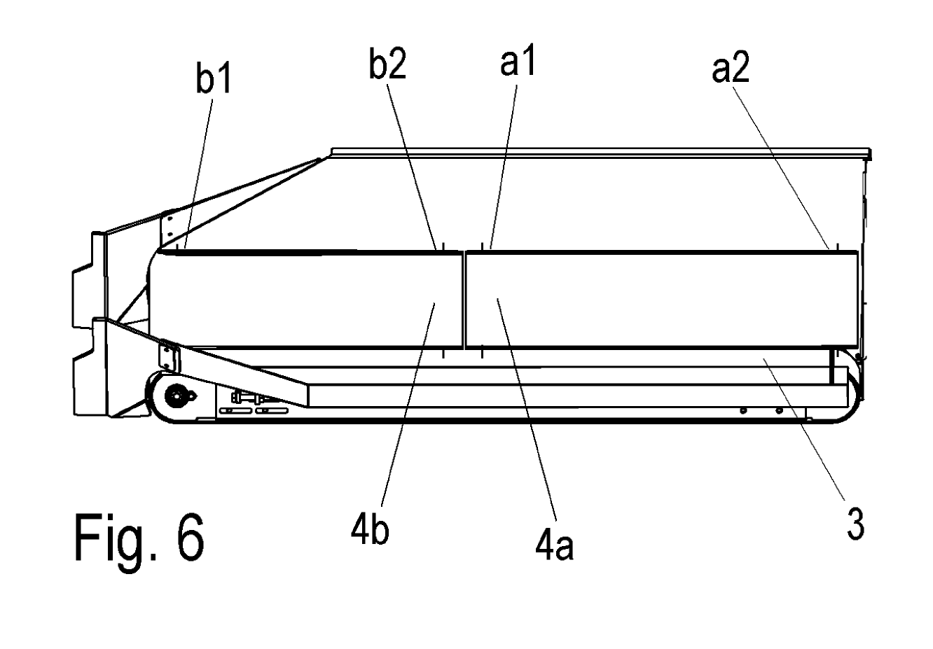

FIG. 6 illustrates a configuration of the conveyor belt 4 according to another embodiment of the invention. The conveyor belt 4 is now split in two, an upstream belt 4a and a downstream belt 4b, each carried by rollers a1, a2 and b1, b2. A support or backing plate for the lower side of the conveyor belts may be disposed between the respective sets of rollers a1, a2 and b1, b2. The dividing line between the two conveyor belts is essentially placed where the imaginary dividing line 4d was shown in FIG. 4. In the first part of the singulating operation the upstream conveyor belt is held stationary, and the fruit is rotated by the conveyor belt 3, essentially moving forward at half-speed when compared to the speed of conveyor belt 3 and breaking up the portion that was discharged by the hopper as described with respect to FIG. 1.

In the second phase of the singulating operation the conveyor section 4a is now set in motion. This means that the remaining fruit placed in this area is now in contact with) two forward moving conveyor belts 3 and 4a, followed by 3 and 4b, and hence moves forward at full speed without rotating.

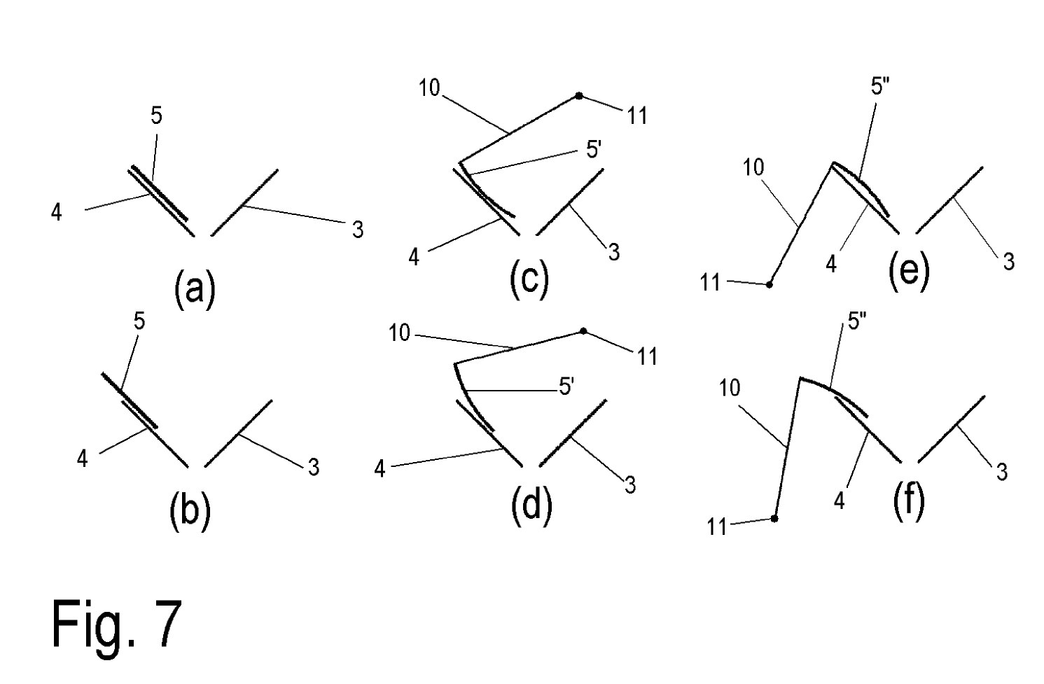

FIG. 7 shows in cross section the geometrical relationships between the V-shaped channel 3, 4 and the plate 5 that prevents access to the movement of the conveyor belt surface 4 during part of the singulating operation. The geometrical relationship between the plate 5 and the conveyor belt surface 4 is shown in (a), and in (b) is shown the relationship after the plate has been moved in its plane. The movements of the conveyor belt surfaces should be considered to be out of the paper towards the viewer.

According to a further embodiment of the invention, such a plate may be replaced by a cylindrical surface 5′ or 5″ that performs the same role as the plate 5 of shielding the items to be singulated from the moving conveyor belt surface 4. This is shown in (c) and (e). In order that such a cylindrical surface may be moved, it is expedient to fix it to brackets 10 that rotate around points 11 of the cylinder axis; here only one is shown. There are two possible ways that the cylindrical surfaces may be disposed, which is shown in (c) and (e), and subsequent to the movement to expose the underlying conveyor belt surface 4, the geometrical relationships are as shown in (d) and (f), respectively. The axes of rotation 11 may hence be disposed above the V-shaped structure 3, 4 (as in (c) and (d)) or above it (as in (e) and (f)). As an example only, the angle of the bracket 10 is changed by about 15 degrees. One skilled in the art may determine the practical disposition in dependence of the other equipment that surrounds the core of the singulator.

Further, the position of the dividing line between the sections of belt conveyor 4 (the changeover between belt conveyors 4a and 4b) that carry out different functions may be optimized according to the requirements of the equipment, such as friction, size of the items to be singulated, and the speed of the conveyor belts 3 and 4. This determination falls within the abilities of the skilled person.

As may be understood by one of ordinary skill in the art, the embodiments described herein address the problem is that packing large rounded articles in smallish bags requires singulation. According to the invention, a full portion is released at the upstream end of a V-shaped structure created by conveyor belts. The V-shaped structure carries the rounded articles to the packing station. At the beginning of the operation, a section of one side of the V-shaped structure is prevented from contributing to the forward transport of the articles, and they are rotated by the other side of the V-shaped structure. As the operation proceeds while the portion is broken up, the inactive section of the conveyor belt is made active, and the articles are now carried singly at full speed to the packing station. As is illustrated herein, using the configuration described herein, a simple and efficient singulation system is provided.

The foregoing description of the specific embodiments will so fully reveal the general nature of the present invention that others skilled in the art can, by applying current knowledge, readily modify or adapt for various applications such specific embodiments without undue experimentation and without departing from the generic concept, and therefore, such adaptations and modifications should and are intended to be comprehended within the meaning and range of equivalents of the disclosed embodiments. It is to be understood that the phraseology or terminology employed herein is for the purpose of description and not of limitation. The means, materials, and steps for carrying out various disclosed functions may take a variety of forms without departing from the invention.

Hence, the expressions “means to . . . ” and “means for . . . ”, or any method step language, as may be found in the specification above and/or in the claims below, followed by a functional statement, are intended to define and cover whatever structural, physical, chemical, or electrical element or structure, or whatever method step, which may now or in the future exist which carries out the recited functions, whether or not precisely equivalent to the embodiment or embodiments disclosed in the specification above, i.e., other means or steps for carrying out the same function can be used; and it is intended that such expressions be given their broadest interpretation.

Additionally, the term “comprising” or “comprises” in the present application is intended to convey the idea of a collection of items that are relevant for the present invention, but it does not exclude that further items may be present and/or relevant. The term “comprising” is not intended to convey the idea of a completeness to the exclusion of other items, which would be better described by the expression “consisting of”.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All) changes which come within the meaning and range of equivalency of the claims are to be embraced within their scope.

What is claimed is:

1. A singulator for handling rounded items, the singulator comprising:
a plurality of conveyor belts for transporting the rounded items, the plurality of conveyor belts defining a V-shaped channel having two inwards-facing surfaces of opposing conveyor belts, in which one surface of one of the opposing conveyor belts has defined a downstream section and an upstream section,
wherein the said upstream section comprises a holder for holding the rounded items stationary with respect to the one surface of the conveyor belt in a first phase of a singulation operation, said upstream section further comprising a movement mechanism for enabling the forward movement of the one surface of the conveyor belt in a second phase of the singulation operation.

2. A singulator according to claim 1, wherein the holder comprises a plate covering the upstream section in order that the rounded items are not in contact therewith, and wherein the movement mechanism is configured to displace said plate in its plane to permit contact between the rounded items and the upstream section.

3. A singulator according to claim 1, wherein the downstream section and the upstream section are separate conveyor belts on the same side of the V-shaped channel, and wherein the holder causes the upstream conveyor belt to be immobile, and movement mechanism comprises a means for moving said upstream conveyor belt forward.

4. A singulator according to claim 2, wherein the plate is hinged at one point and is capable of being swung upwards out of the way of the upstream surface it covers.

5. A singulator according to claim 2, wherein the plate is capable of being displaced laterally upwards out of the way of the upstream surface it covers.

6. A singulator according to claim 2, wherein the displaceable plate has means for adjusting of the length along the conveyor of the lower edge of said plate.

7. A singulator according to claim 3, wherein the downstream section moves at a speed that is equal to or greater than the speed of the opposing conveyor belt, and that the upstream section does not move during the first phase of the singulation operation and is put in motion at the same speed as the downstream section during the second phase of the singulation operation.

8. A singulator according to claim 1, wherein the holder comprises a section of a cylindrical shell with an axis parallel to the V-shaped channel covering the upstream section such that that the rounded items are not in contact therewith, and wherein movement mechanism displaces the cylindrical shell in a circle concentric to the cylindrical shell to permit contact between the rounded items and the upstream section.

9. A method of using the singulator according to claim 1 for singulating rounded fruit, the method comprising:
emptying a portion of a pre-determined number or weight of fruit into the upstream section of the V-shaped channel while the upstream section of the one surface of the conveyor belt is stationary;
permitting the downstream section and an opposing conveyor belt to the one surface of the conveyor belt to arrange the fruit into a row;
causing the upstream section move with a speed corresponding to the speed of the opposing conveyor belt, thereby transporting the remaining fruit of the portion; and
transporting the singulated fruit for further processing.

10. The method according to claim 9, wherein the means for holding the surface of the upstream section stationary comprises a section of a cylindrical shell with an axis parallel to the V-shaped channel covering the upstream section such that that the rounded items are not in contact therewith, and wherein the means for the forward movement of the upstream section comprises a means for displacing the cylindrical shell in a circle concentric to the cylindrical shell to permit contact between the rounded items and the upstream section.

11. A method of using the singulator according to claim 2 for singulating rounded fruit, the method comprising:
emptying a portion of a pre-determined number or weight of fruit into the upstream section of the V-shaped channel while the upstream section of the one surface of the conveyor belt is stationary;
permitting the downstream section and an opposing conveyor belt to the one surface of the conveyor belt to arrange the fruit into a row;
causing the upstream section move with a speed corresponding to the speed of the opposing conveyor belt, thereby transporting the remaining fruit of the portion; and
transporting the singulated fruit for further processing.

12. The method according to claim 11, wherein the plate is hinged at one point and is capable of being swung upwards out of the way of the upstream surface it covers.

13. The method according to claim 11, wherein the plate is capable of being displaced laterally upwards out of the way of the upstream surface it covers.

14. The method according to claim 11, wherein the displaceable plate has means for adjusting of the length along the conveyor of the lower edge of said plate.

15. A method of using the singulator according to claim 3 for singulating rounded fruit, the method comprising:
emptying a portion of a pre-determined number or weight of fruit into the upstream section of the V-shaped channel while the upstream section of the one surface of the conveyor belt is stationary;
permitting the downstream section and an opposing conveyor belt to the one surface of the conveyor belt to arrange the fruit into a row;
causing the upstream section move with a speed corresponding to the speed of the opposing conveyor belt, thereby transporting the remaining fruit of the portion; and
transporting the singulated fruit for further processing.

16. The method according to claim 15, wherein the downstream section moves at a speed that is equal to or greater than the speed of the opposing conveyor belt, and that the upstream section does not move during the first phase of the singulation operation and is put in motion at the same speed as the downstream section during the second phase of the singulation operation.
